(19) United States
(12) Patent Application Publication
(10) Pub. No.: US 2003/0099098 A1
(43) Pub. Date: May 29, 2003

(54) RF connector with chip carrier and coaxial to coplanar transition

(76) Inventor: Jose Schutt-Aine, Savoy, IL (US)

Correspondence Address: MCKENNA LONG & ALDRIDGE LLP, 1900 K STREET, NW, WASHINGTON, DC, 20006, US

(21) Appl. No.: 09/990,877

(22) Filed: Nov. 23, 2001

(51) Int. Cl. H01R 9/05

(52) U.S. Cl. 361/791

(57) ABSTRACT

A connector assembly for a radio frequency (RF) signal includes a body, a flange connected to the body and having a cavity, and a plurality of pins extending from the flange, in which the cavity of the flange receives a chip carrier and the pins contact the chip carrier so as to minimize the signal path from the connect pin to the device in the chip carrier.

### BACKGROUND OF THE INVENTION

1. Field of the Invention

The invention relates generally to radio frequency (RF) devices and, more particularly, RF connectors of the type that connect a planar electric circuit to a coaxial system. Although a wide range of applications are contemplated, the RF connector may be particularly useful in broadband microwave circuits such as radios, televisions, video cassette recorders, satellite equipment, splitters, and other television distribution equipment.

2. Discussion of the Related Art

Planar electrical circuits are well known in the art, particularly in the field of microwave technology. In order to couple planar electrical circuits to other devices in a microwave system, RF connectors are used to connect a coaxial cable or component to a planar conductor for applications where RF signals must be terminated or interconnected through a coaxial cable which carry high frequency signals. Since two different modes of electrical propagations are used, i.e., coaxial and planar, it is desirable to match the characteristic impedance of both in addition to the connector. The connectors typically include a threaded coupling and locking mechanism at one end and a signal pin extending from a flange at the other end.

Prior art RF connectors typically comprise a metallic coaxial connector body assembly, one end of which mates with a coaxial connector. The other end of the connector body usually includes a flange, which may be placed in abutment against a side of the planar circuit. A single signal conducting pin extends coaxially through the connector body and has one end thereof formed to electrically connect the conducting pin to a center pin in a coaxial connector. The other end of the conducting pin extends outwardly from the flange of the connector body to electrically connect to a planar conductor, which runs near the side of the planar circuit structure. A single signal pin extends coaxially through the connector body and has one end thereof formed to electrically connect the signal pin to the center pin in the coaxial connector.

A prior art application of a standard 2.4 mm connector is illustrated in FIG. 1. The connector includes an inner cylindrical portion 3 surrounded by an outer cylindrical annular portion 5. A flange 7 extends from a distal end of outer cylindrical annular portion 5 and is provided with a plurality of holes 9 for screw mounting the connector to a printed circuit board, for example, (PCB not shown). Alternatively, the flange 7 can be mounted to a PCB or a case by means of surface mount solder, through-hole solder, conductive epoxy or press-fit feet. The outer cylindrical annular portion may be provided with an identification (ID) groove 2 and a plurality of threads 10, or other types of RF mating for connection to a threaded coaxial ground contact sleeve of the coaxial cable (not shown) to effect mechanical and electrical contact between the body 1 and mating connector. The inner cylindrical portion of the body 1 is left unplated and a metallic center contact 11 is press-fit therein. The metallic center contact 11 maybe formed from a copper alloy with a gold over nickel finish. Selective plating of the body 1 provides a conductive ground which is electrically isolated from the center contact. The contact 11 can be screw machined or stamped and formed in a well-known manner, and can be attached to an appropriate PCB trace via surface mount solder, a press-fit connection, through-hole solder or conductive epoxy.

The relative dimensions of the connector, contact, and flange are determined by the desired characteristic impedance for the connector, usually 50 ohms. Appropriate selection of a dielectric platable material, for example, acetal dielectric resin manufactured by E. I. DuPont de Nemours and Company and plating material can be used to achieve the desired characteristic impedance. The prior art connector is fabricated using a known assembly procedure, such as the procedure used to assemble an Amphenol Incorporated 82-368 N-style jack connector/4-hole flange panel plug. This type of 2.4 mm connector was developed by Hewlett Packard, Amphenol and M/A-COM for use to 50 GHz (the first waveguide mode is reached at 52 GHz) and is manufactured by SRI Connector Gage Co., model no. 27-131-1000.40 (M/A-COM refers to this as OS-2.4/OS-50).

The typical dimensions of the connector and the flange are shown in the table below.

| Element | Mils |
|---|---|
| A | 76 |
| B | 24 |
| C | 305 |
| D | 250 (Max) |
| E | 45 |
| F | 520 |
| G | 7.0 × 75-6 g |
| H | 340 |
| I | 102 4X |
| J | 500 sq. |
| K | 60 |

A cross-sectional view of the prior art connector is illustrated in FIG. 2. The connector comprises a body 1. The outer cylindrical annular portion 5 may include an internally threaded cover 4 that is free to rotate relative to the remainder of the body to rigidly join the RF connector to a complementary male connector (not shown). The prior art connector has only one signal pin extending from the flange 7. One end of the connector can accommodate a fiber and the other end of the connector may be mounted to a case having a chip carrier.

A bottom-view of the prior art 4-hole flange without the chip carrier is illustrated in FIG. 3A. The typical values for W_{f} and L_{f} are typically 340 and 500 mils, respectively. A bottom view of the prior art 2-hole flange is illustrated in FIG. 3B. The typical values for W_{1f}, W1f, and L_{f} are 481, 625, and 223 mils, respectively.

However, the use of the 2.4 mm connectors in the manner shown in FIGS. 1, 2, 3A, and 3B has an intermittent AC return path and poor signal integrity at high frequencies. This is because such prior art design has an inherent problem of having the chip carrier physically far away from the connector, which results in a long signal path. In high frequency applications, the length of the signal path becomes critical. Thus, it is desirable to create a design that will reduce the signal path between the connector and the chip carrier.

### SUMMARY OF THE INVENTION

Accordingly, the present invention is directed to an RF connector that substantially obviates one or more of the problems due to limitations and disadvantages of the related art.

An advantage of the present invention is an RF connector capable of providing good signal integrity.

Another advantage of the present invention is an RF connector and chip carrier assembly with minimal signal path.

Additional features and advantages of the invention will be set forth in the description that follows, and in part will be apparent from that description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a connector assembly for a Radio Frequency (RF) signal path in an electronic circuit, includes: a flange portion having a cavity; a chip carrier formed in the cavity; and a coplanar configuration of a plurality of pins extending from the cavity.

In another aspect of the present invention, a coplanar pin configuration includes a plurality of pins, wherein at least one pin has an insert for a chip carrier.

In another aspect of the present invention, a flange portion of a connector assembly includes: a chip carrier provided inside a cavity in the flange portion; a plurality of holes; and an inner cylindrical portion having a coplanar configuration of a plurality of pins.

In another aspect of the present invention, a chip carrier includes: a ceramic substrate having a first portion and a second portion, the first portion having a recess capable of receiving a chip, the second portion of the substrate having a hole; a plurality of pins having a coplanar configuration formed at the hole; a plurality of capacitors formed on the substrate; and a plurality of resistors formed on the substrate.

In another aspect of the invention, an RF connector assembly includes a main body; a flange connected to the main body and having a cavity for receiving a chip carrier; a pin extending from the flange, whereby a signal path between the pin of the RF connector and a chip in the chip carrier is minimized.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a view of a typical prior art application of an RF connector assembly and 4-hole flange;

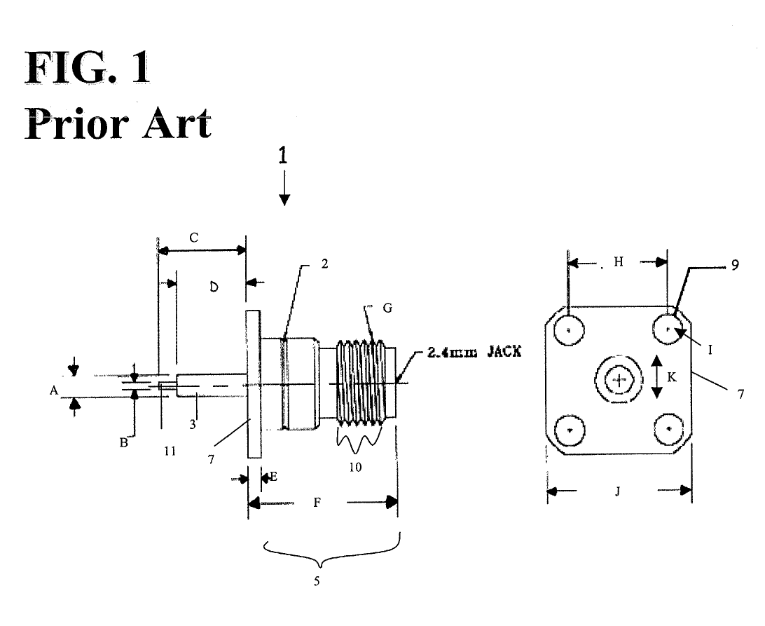

FIG. 2 is a side view of a typical prior art RF connector assembly;

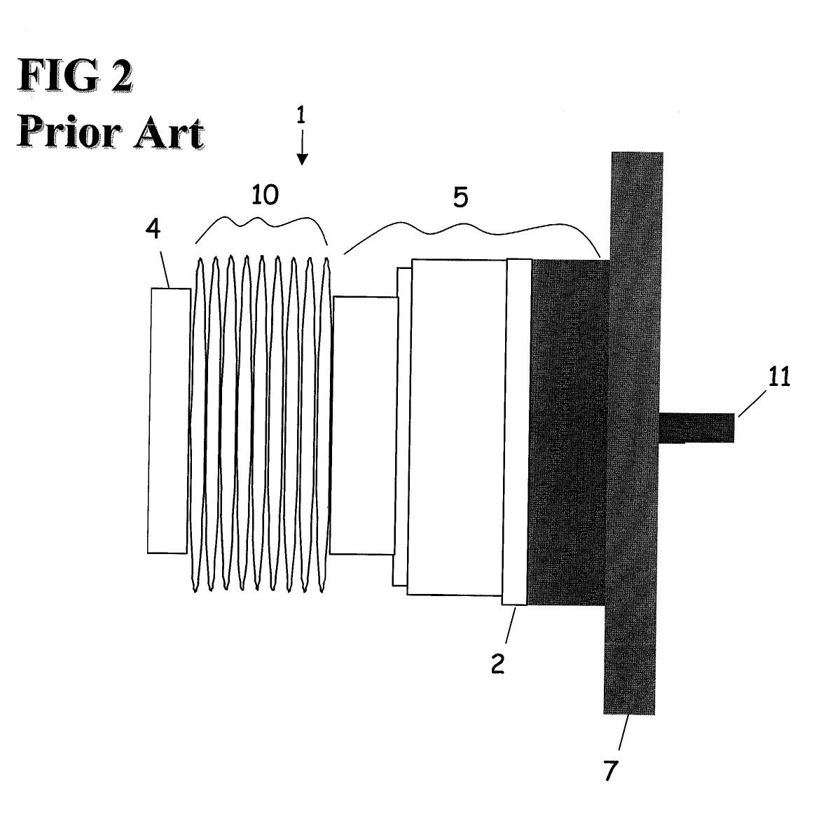

FIG. 3A is a front view of a typical prior art 4-hole flange;

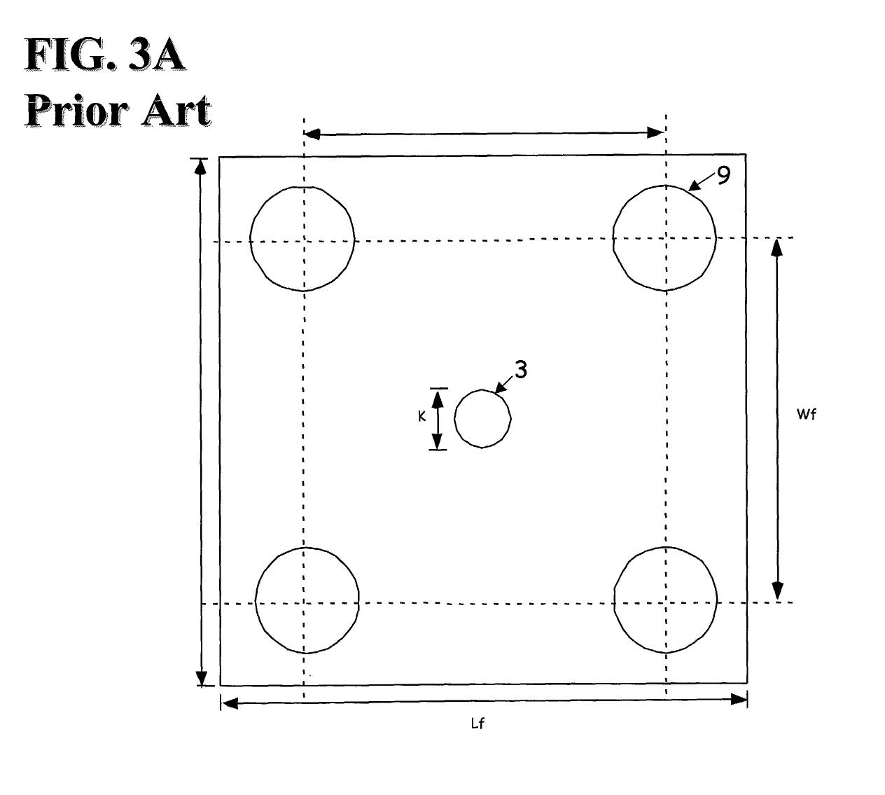

FIG. 3B is a front view of a typical prior art 2-hole flange;

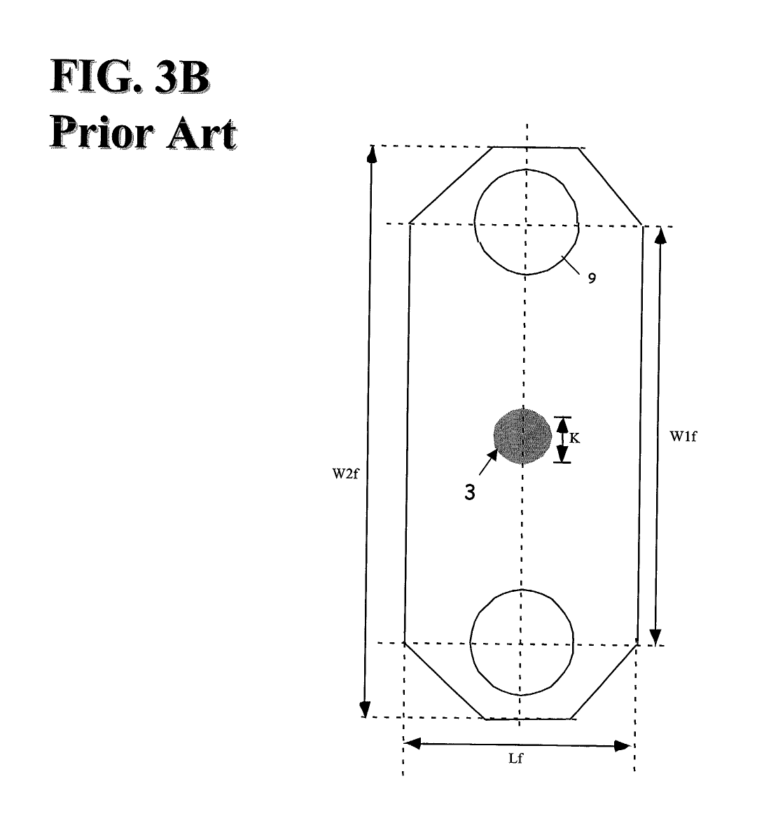

FIG. 4A is a first side view of the RF connector assembly according to an embodiment of the present invention;

FIG. 4B is a cross-sectional view of the prior art connector and the connector according to an embodiment of the present invention;

FIG. 5 is a second side view of the chip carrier in the RF connector assembly of FIG. 4A, where the second side view is 90 degrees rotated in the azimuthal direction from the first side view of FIG. 4A);

FIG. 6A is a front view of the 4-hole flange and chip carrier according to FIG. 4A;

FIG. 6B is a front view of the 2-hole flange and chip carrier according to FIG. 4B;

FIG. 6C is another view of the 4-hole flange and chip carrier according to FIG. 4A;

FIG. 7 is a longitudinal cross-sectional of the connector assembly of FIG. 4A;

FIG. 8 is a top view of the chip carrier with a chip according to FIG. 4A;

FIG. 9 is a second side view (similar view as FIG. 5) of the chip carrier in the connector according to another embodiment of the invention;

FIG. 10A is a front view of the 4-hole flange and chip carrier according to the embodiment of FIG. 9;

FIG. 10B is a front view of the 2-hole flange and chip carrier according to the embodiment of FIG. 9;

FIG. 11 is a top view of the chip carrier with a chip according to the embodiment of FIG. 9;

FIG. 12 shows a calibration standard open circuit for the chip carrier of FIG. 8;

FIG. 13 shows a calibration standard short circuit for the chip carrier of FIG. 8;

FIG. 14 shows a calibration standard load circuit for the chip carrier of FIG. 8;

FIGS. 15A, 15B and 15C show all three calibration standards shown in FIGS. 12, 13 and 14, respectively, for the chip carrier of FIG. 11;

FIG. 16 shows an indium phosphide wafer with photodetectors;

FIG. 17 shows a typical photodetector that is used in the chip carrier of the present invention; and

FIG. 18 illustrates a photodetector bias circuit schematic.

### DETAILED DESCRIPTION OF THE ILLUSTRATED EMBODIMENTS

Reference will now be made in detail to an illustrated embodiment of the present invention, the example of which is shown in the accompanying drawings.

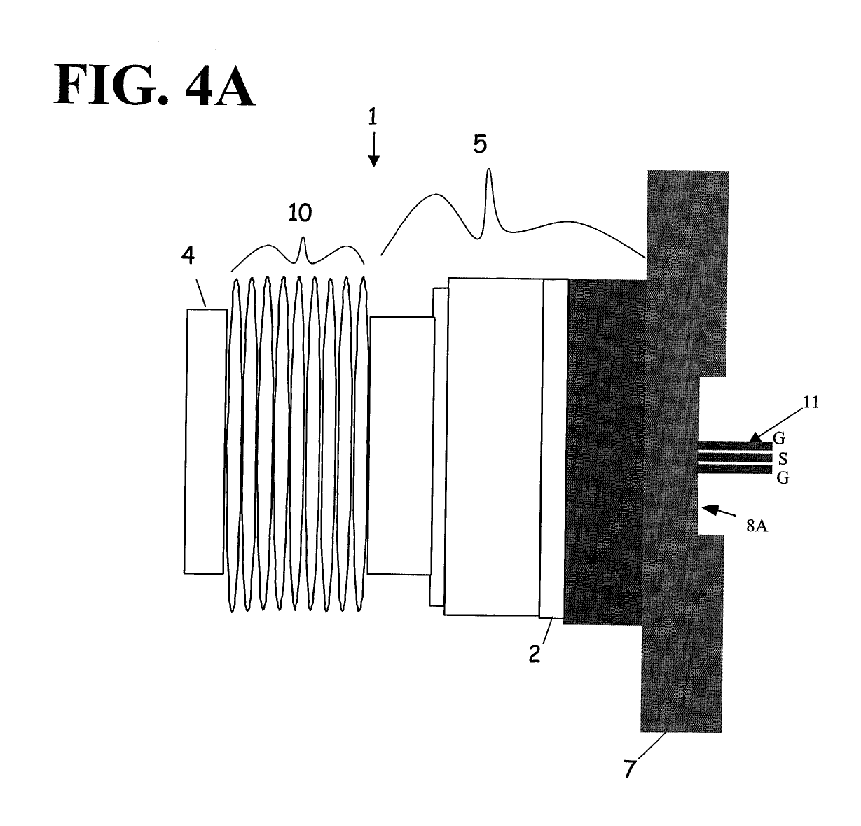

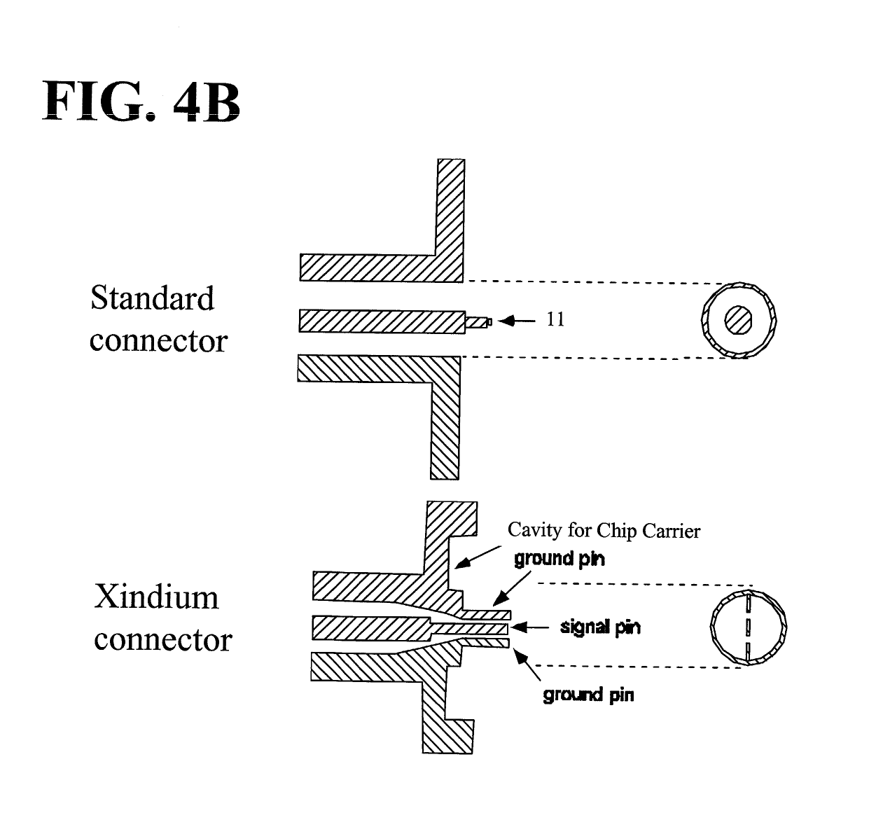

FIG. 4A a first side view of the RF connector assembly according an embodiment of the present invention. As shown in FIG. 4A, similar to the prior art connector, one end of the connector accommodates a fiber, the other end, however, includes a flange portion 7 having a multiple-pin coplanar configuration, such as a three-pin coplanar configuration and a cavity 8A. The cavity 8A is preferable for receiving a chip carrier 8, which will be discussed in more detail. The outer cylindrical annular body 5 may include an internally threaded cover 4 that is free to rotate relative to the remainder of the outer body to rigidly join the RF connector to a complementary connector (not shown). The physical details of the complementary connector are well known and thus will not be discussed in this application.

In FIG. 4B, only one metallic center contact of the prior art connector extends from the flange portion. In contrast, the connector assembly of the present invention comprises a connector body having a ground-signal-ground (3) pin configuration and a chip carrier insert (a cavity) for accommodating a chip carrier (not shown). A significant benefit of the ground-signal-ground pin configuration is that it provides a constant AC return path and ensures signal integrity at high frequencies such as at 50 GHz.

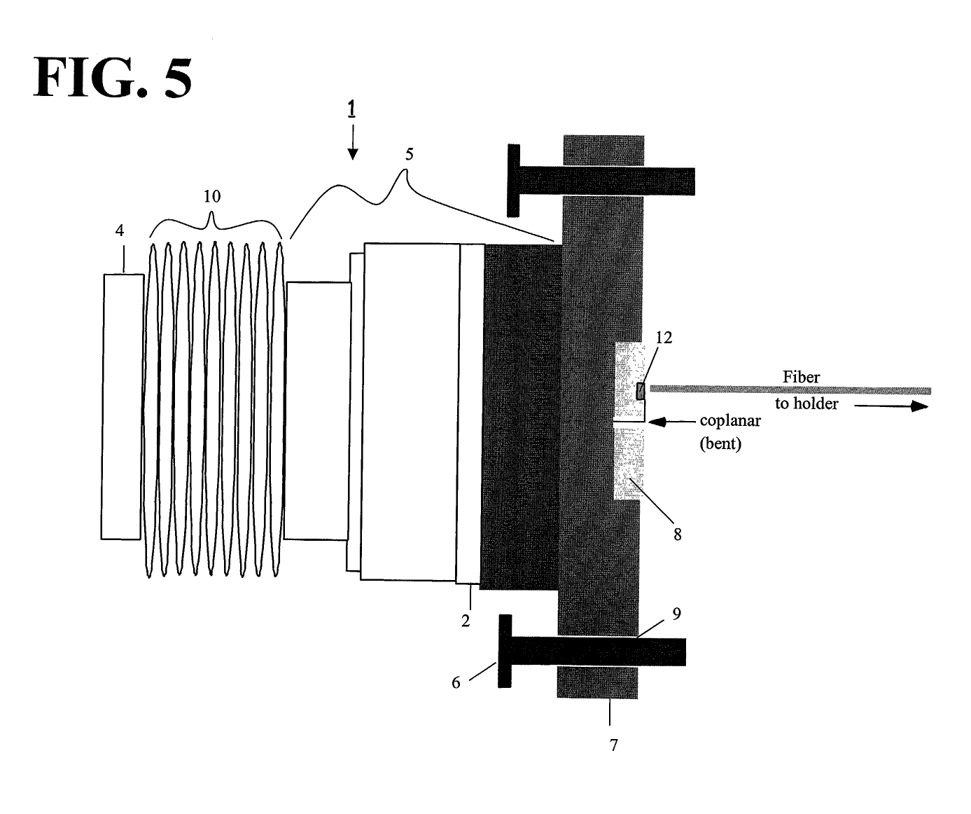

FIG. 5 is a second side view of the RF connector shown in FIG. 4A. Here, the second side view is 90 degrees rotated in the azimuthal direction from the first side view of FIG. 4A. As shown in FIG. 5, the chip carrier 8 having a chip 12 is positioned in the cavity 8A of the flange 7. The cavity 8A may be made deep enough to receive the chip carrier 8 so that the chip carrier is substantially flush with the surface of the flange 7. When the chip carrier 8 is placed in the cavity 8A, the three pins 11 are soldered to the appropriate contacts of the chip carrier 8. As shown in FIG. 5, the conductive line or trace on the chip carrier 8 that contacts the signal pin of the RF connector is also coplanar. The line may be bent to contact the chip 12 in the chip carrier 8.

An important benefit to placing the chip carrier directly on the flange of the RF connector is the significant reduction in the length of the signal path from the RF connector pin to the device or chip 12 in the chip carrier 8. The design of the present invention can control the length of the signal path to be as short as less than 40 mils or as long as in the prior art, if desired. Thus, the present invention allows for the signal path length to be less than 500 mils, 400 mils, 300 mils, 200 mils, 100 mils, or 40 mils. The shorter the signal path length, the better the signal.

Referring to FIG. 5, the flange portion 7 is shown with a plurality of screws 6 for screw mounting the connector to a printed circuit board (PCB not shown) through a plurality of holes 9. Alternatively, the flange 7 can be mounted to a case by several other ways including surface mount solder, through-hole solder, conductive epoxy or press-fit feet. The chip 12 may include a compound semiconductor device or an optical driver. Such devices include, for example, a photodetector (PD), a PIN diode and a transimpedance amplifier (TIA). The coplanar signal pin may be bent depending on the type of case used for mounting.

Also, the body 1 may be selectively plated so that inner and outer surfaces of the outer cylindrical annular portion 5 and the entire outer surface of the flange 7 are plated with an electrically conductive material such as electroless copper/nickel.

The outer cylindrical annular portion 5 can be provided with a plurality of threads 10 or other types of RF mating for connection to a threaded coaxial ground contact sleeve of the coaxial cable (not shown). Alternatively, the outer cylindrical annular portion 5 can include two or more outward facing plated studs (not shown) to effect mechanical and electrical contact between the body 1 and mating connector. For example, the inner cylindrical portion 3 of the body is left un-plated and a metallic center contact 11 is press-fit therein. The ground pins and the signal pin may be formed with the same material as the prior art metallic center contact. Selective plating of the body 1 provides a conductive ground, which is electrically isolated from the other conductors.

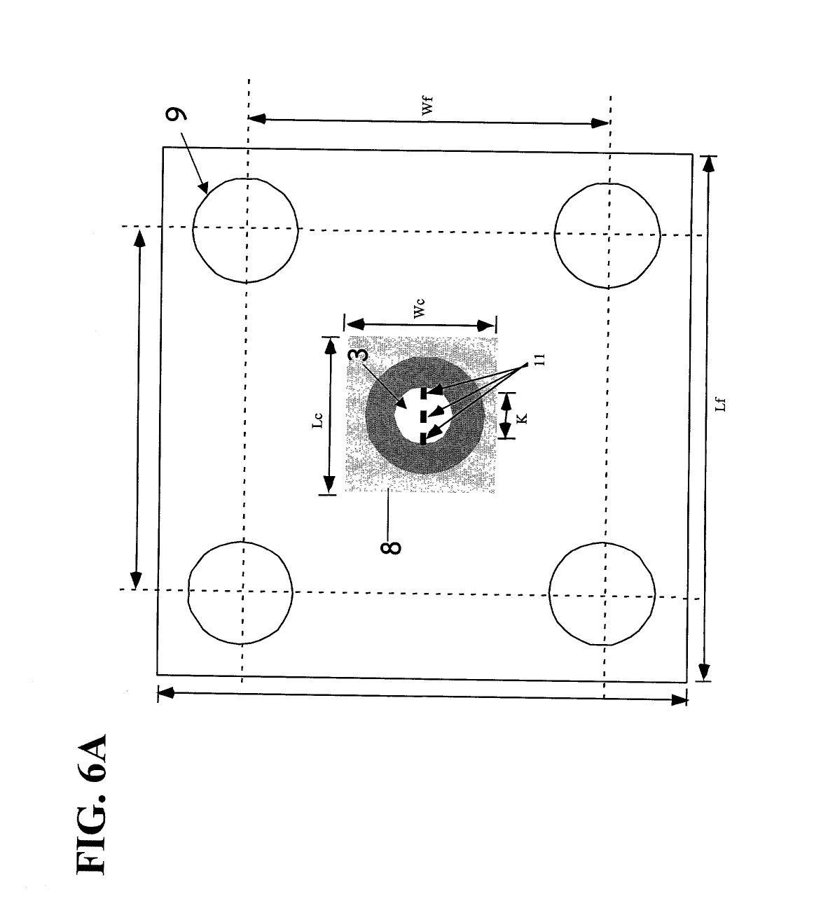

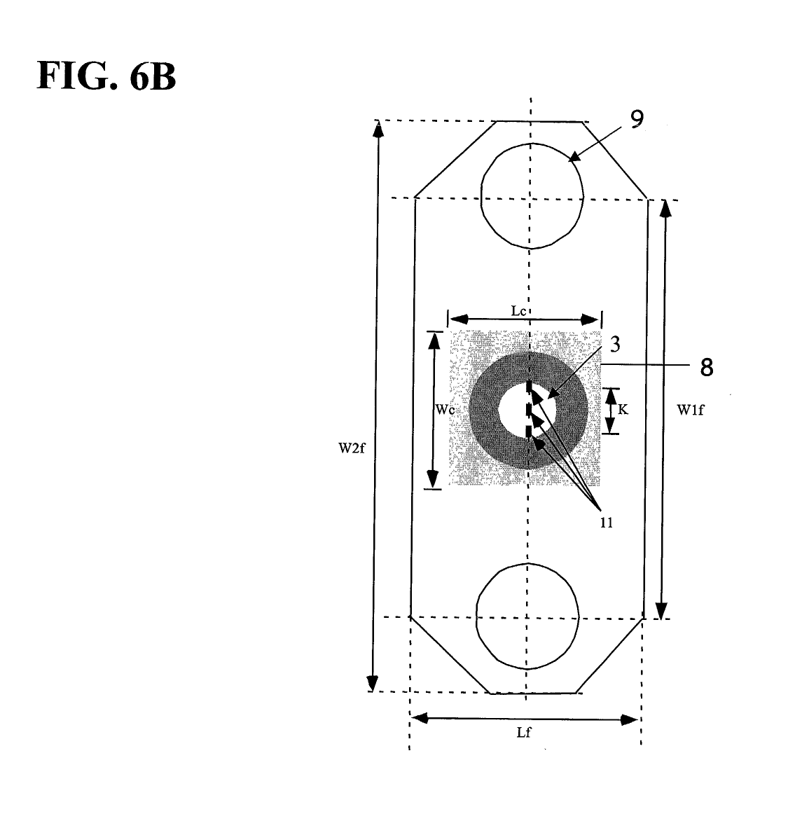

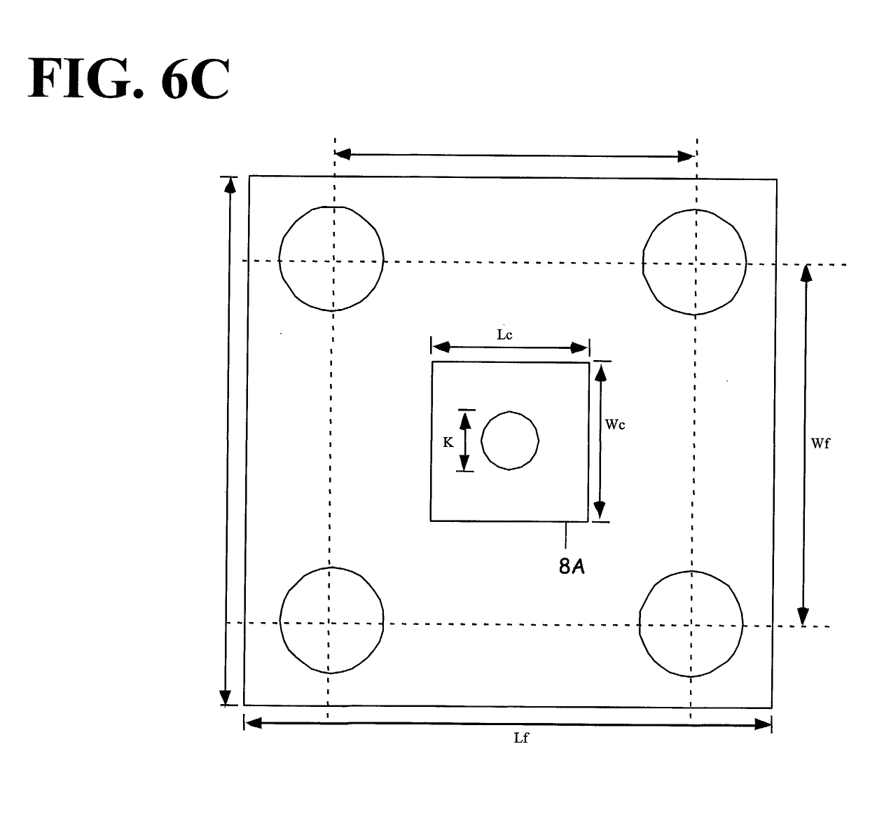

The front view of the 4-hole flange is shown in FIG. 6A. The three coplanar pins 11 are provided in the inner cylindrical portion 3. The dimensions of the chip carrier housing conform to the component size and chip. The typical values for W_{f} and L_{f} may be similar to the prior art. The values for W_{c} and L_{c} of the chip carrier of this embodiment may be 150 mils each.

The front view of a 2-hole flange is shown in FIG. 6B. The three coplanar pins are provided in the inner cylindrical portion 3. The dimensions of the chip carrier housing conform to the component size and chip. The typical values for W_{1f}, W_{2f}, and L_{f} may be similar to the prior art. The values for W_{c} and L_{c} of the chip carrier of this embodiment may be 150 mils each.

Another view of the 4-hole flange having the cavity without the chip carrier mounted is illustrated in FIG. 6C. The typical values for W_{f} and L_{f} are 340 and 500 mils, respectively, and the typical values for W_{c} and L_{c} are 150 mils each.

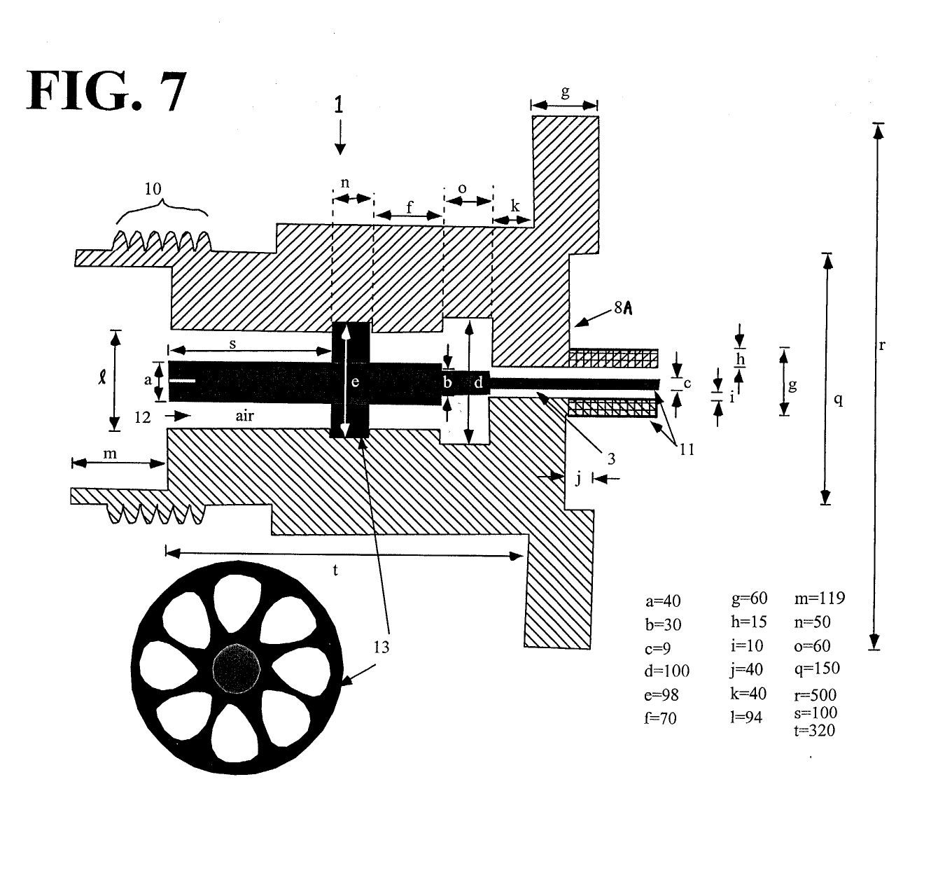

With reference to FIG. 7, a longitudinal cross-sectional top view of the connector assembly is shown comprising a one-piece molded body 3 of dielectric tubular material such as Teflon, centered along an axis, and surrounding the coplanar signal pin within the connector body 1. A flange portion 7, approximately 500 mils in length, extends from a distal end of outer cylindrical annular portion 5, approximately 320 mils in length. A cavity 8A, approximately 150 mils wide for example, is provided for the chip carrier and the three-pin configuration. A support member 13 is preferably provided to prevent the signal pin from moving inside the connector body since there is air surrounding the signal pin. The diameter of the opening 12 is approximately 94 mils. The typical values as discussed are shown in FIG. 7.

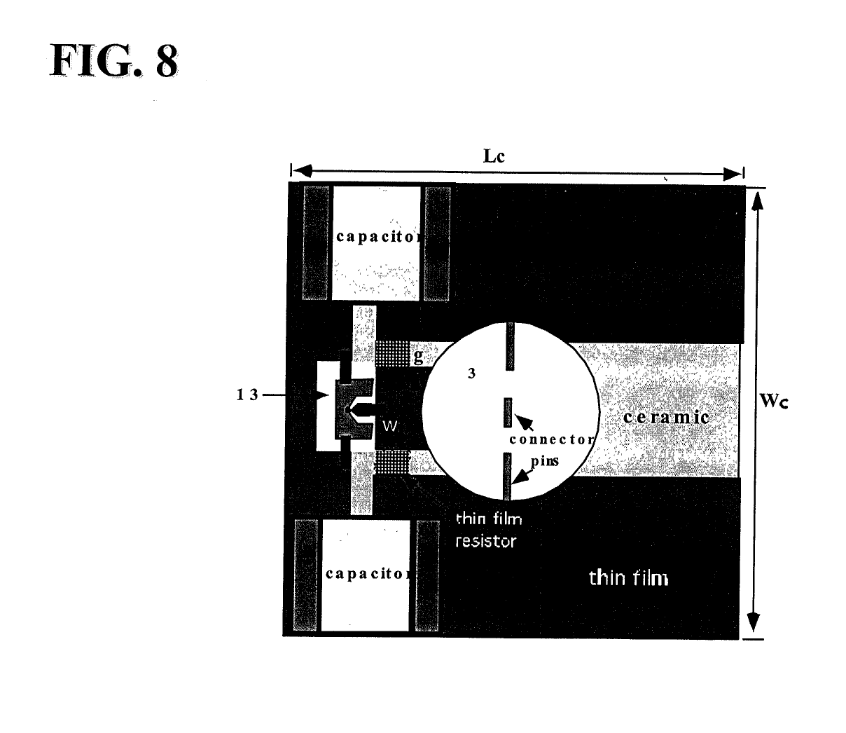

In FIG. 8, a top-view of the chip carrier having a chip is illustrated. A plurality of capacitors and thin film resistors (approximately 100Ω, for example) are formed on the substrate. The chip 12 is provided in a recess 13 about 10 mils deep. The chip carrier 8 can be made of a ceramic substrate. The substrate can be made to a thickness of about 40 mils. The values for “w” and “g” in FIG. 8 are typically 28 and 8 mils, respectively. The diameter of the hole 3 is approximately 60 mils. The values of Wc and Lc are typically 150 mils each.

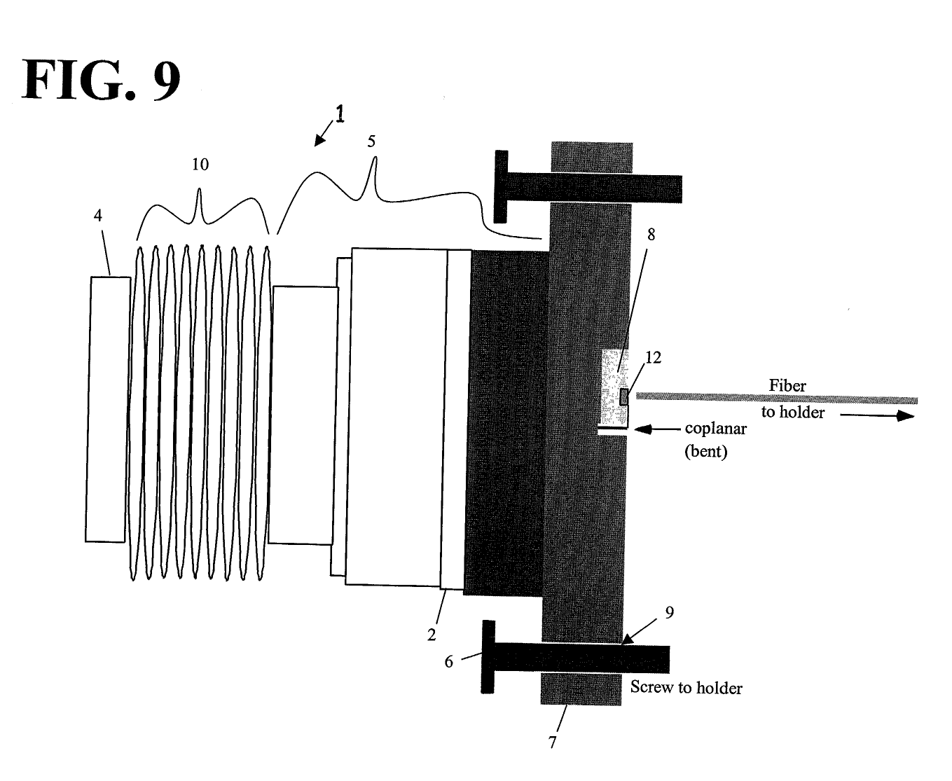

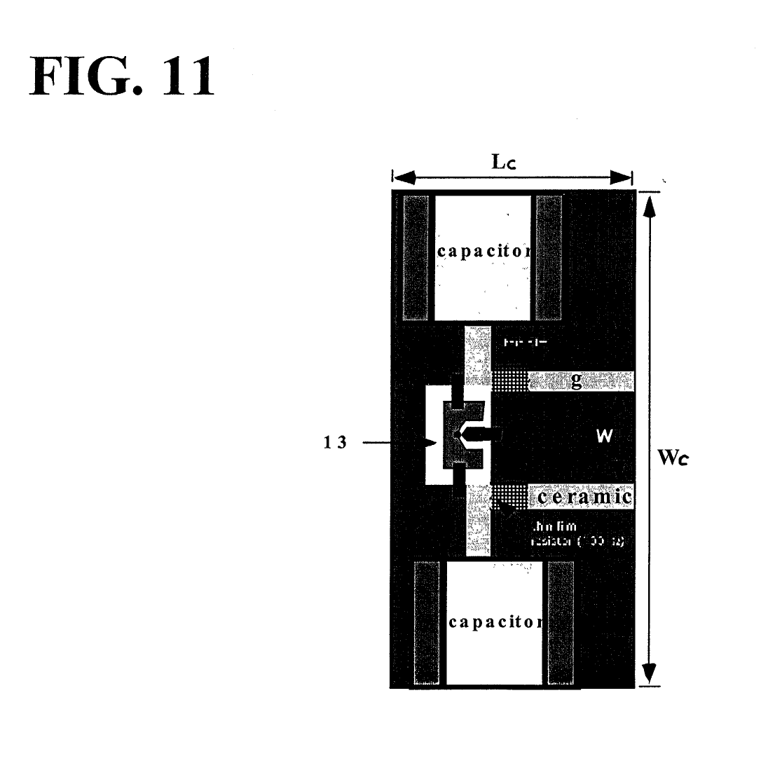

Other embodiments and modifications of the invention are possible. For example, as shown in FIG. 9, a smaller chip carrier may be used. For example, to reduce the size of the chip carrier, the right portion of the chip carrier show in FIG. 8 may be removed, as shown in FIG. 11.

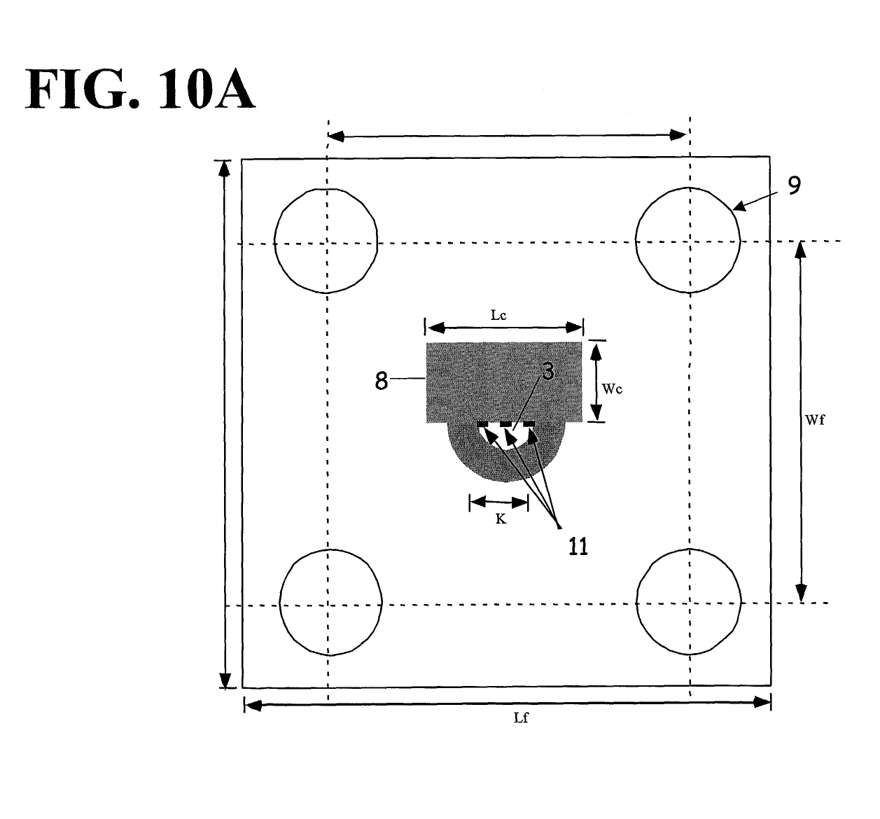

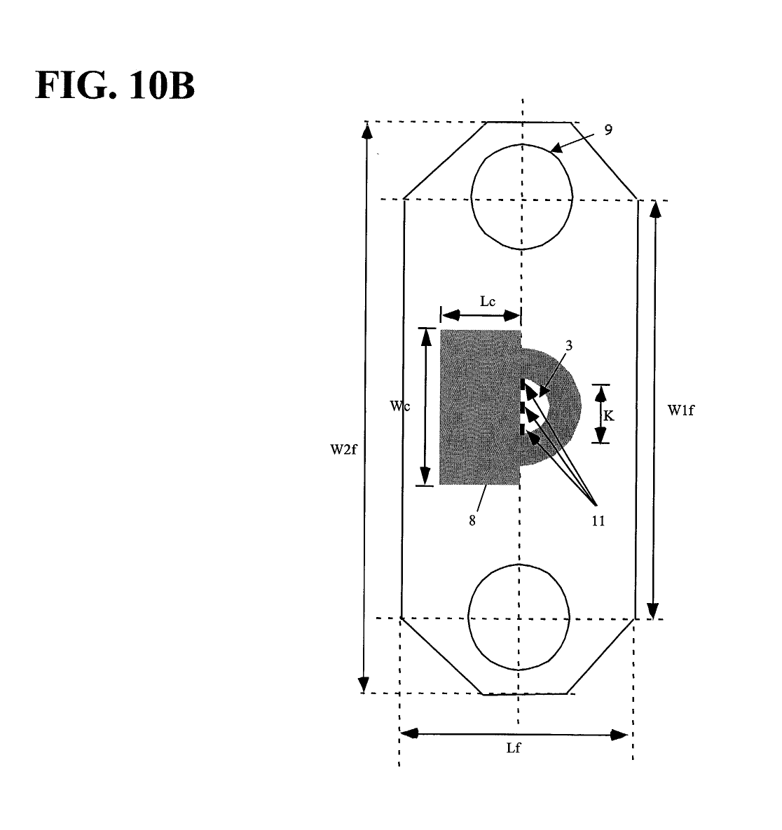

FIG. 10A shows a top view of a 4-hole flange of the embodiment of FIG. 9. The values for W_{f} and L_{f} may be the same as in FIG. 6A and the values for W_{c} and L_{c} of the chip carrier of this embodiment may be, for example, 75 and 150 mils, respectively. FIG. 10B shows a top view of a 2-hole flange of the embodiment of FIG. 9. The values for W_{1f}, W_{2f} and L_{f} may be the same as in FIG. 6B and the values for W_{c} and L_{c} of the chip carrier of this embodiment may be 150 and 75 mils, respectively. As can be seen from FIGS. 10A and 10B, the physical dimension of the chip carrier is smaller than the chip carrier shown in FIGS. 6A and 6B.

FIG. 11 illustrates the top-view of the embodiment of FIG. 9. A plurality of capacitors and thin film resistors (approximately 100Ω) are shown. The chip is provided in a recess of about 10 mils deep. The chip carrier can be made of a ceramic substrate formed to a thickness of about 40 mils. The values for “w” and “g” are typically 28 and 8 mils, respectively. There is no hole in this embodiment. The values of W_{c} and L_{c} are typically 150 and 75 mils, respectively.

Also, although the embodiments shown in FIGS. 4-11 relate to a single connector, it is contemplated that multiple connectors may be molded into a common base, with selective plating and individual press-fit center metallic conductors, to produce a variety of RF devices such as RF splitters or combiners. All such embodiments and modifications are believed to be within the scope of the present invention as defined by the claims appended hereto.

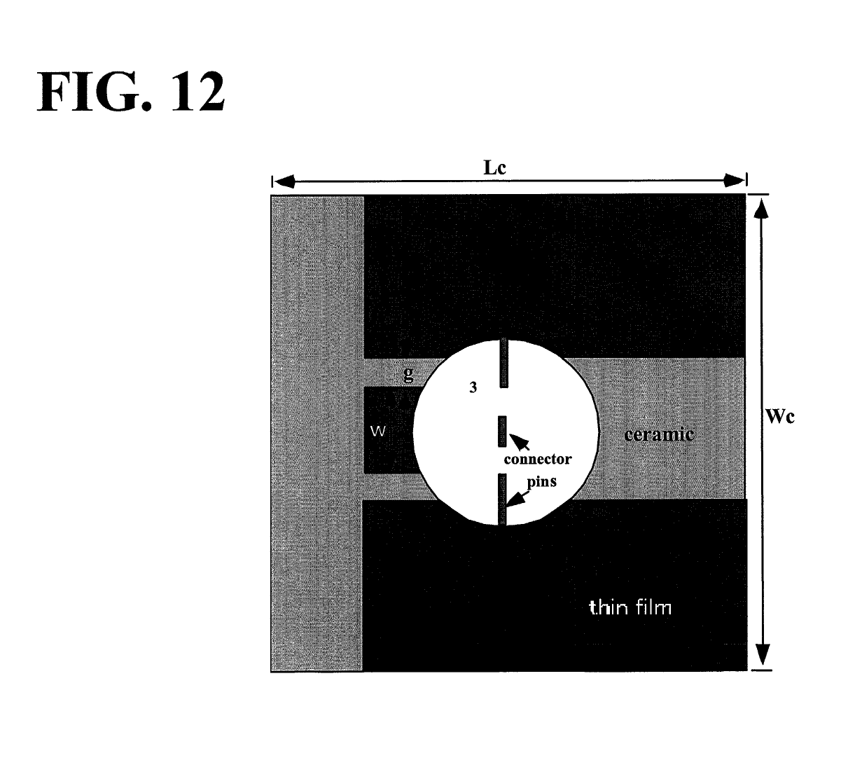

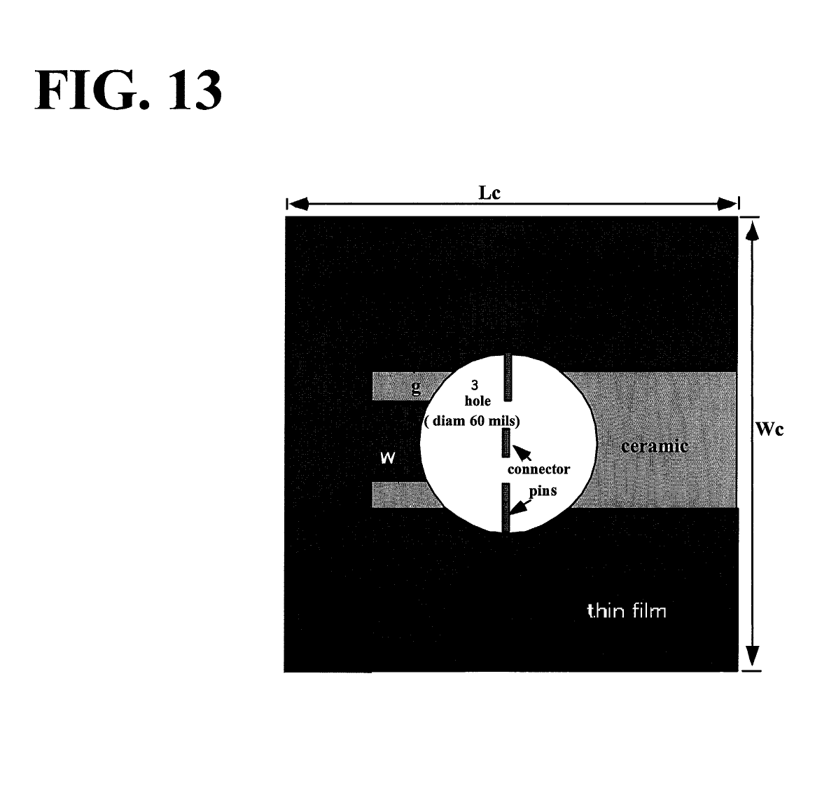

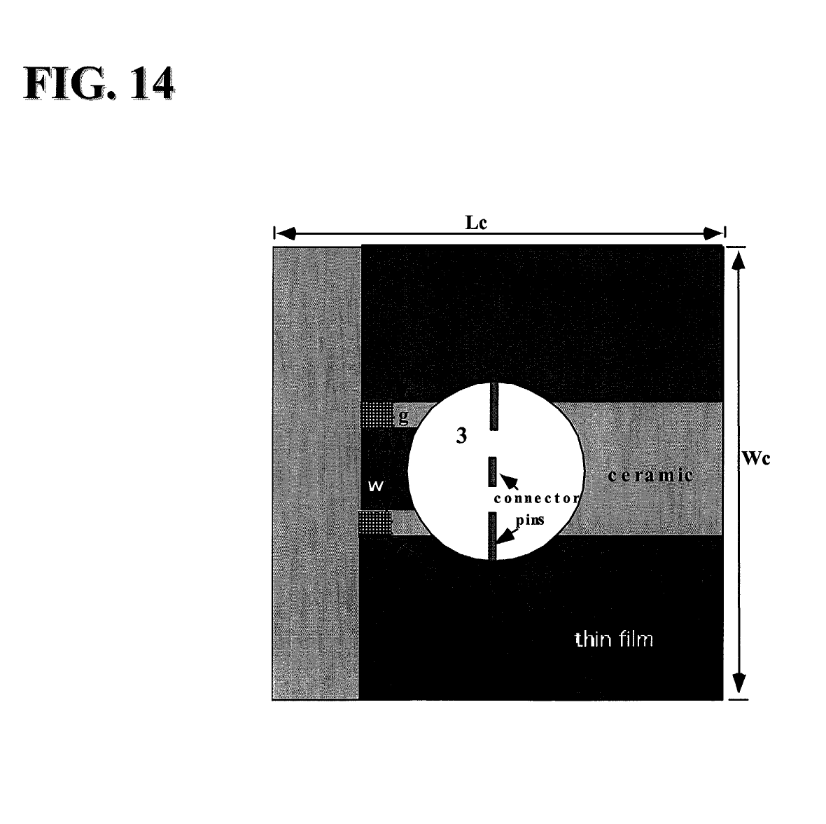

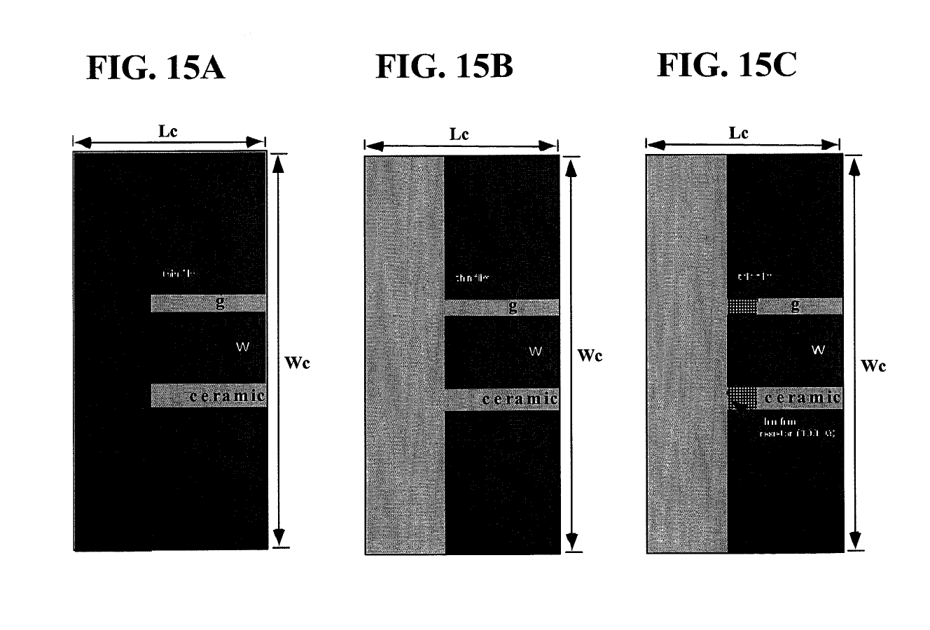

FIG. 12 shows a calibration standard open circuit for the chip carrier of FIG. 8. FIG. 13 shows a calibration standard short circuit for the chip carrier of FIG. 8. FIG. 14 shows a calibration standard load circuit for the chip carrier of FIG. 8. FIGS. 15A, 15B and 15C show another view of all three calibration standards shown in FIGS. 12, 13 and 14, respectively, for the chip carrier of FIG. 11.

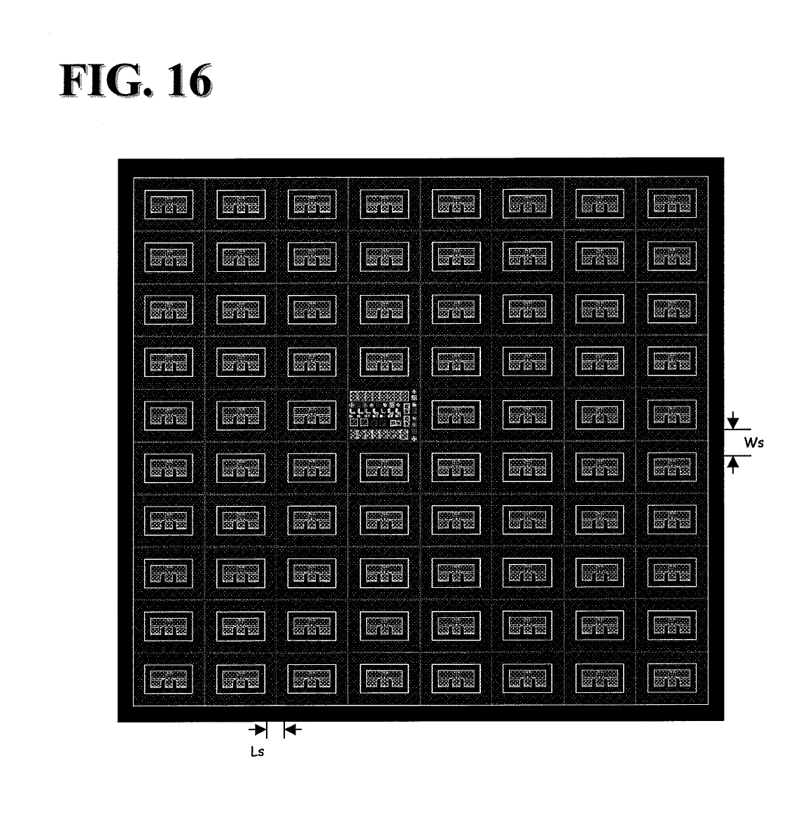

FIG. 16 shows an indium phosphide wafer with photodetectors. The values for Wₛ and Lₛ are typically 250 μm.

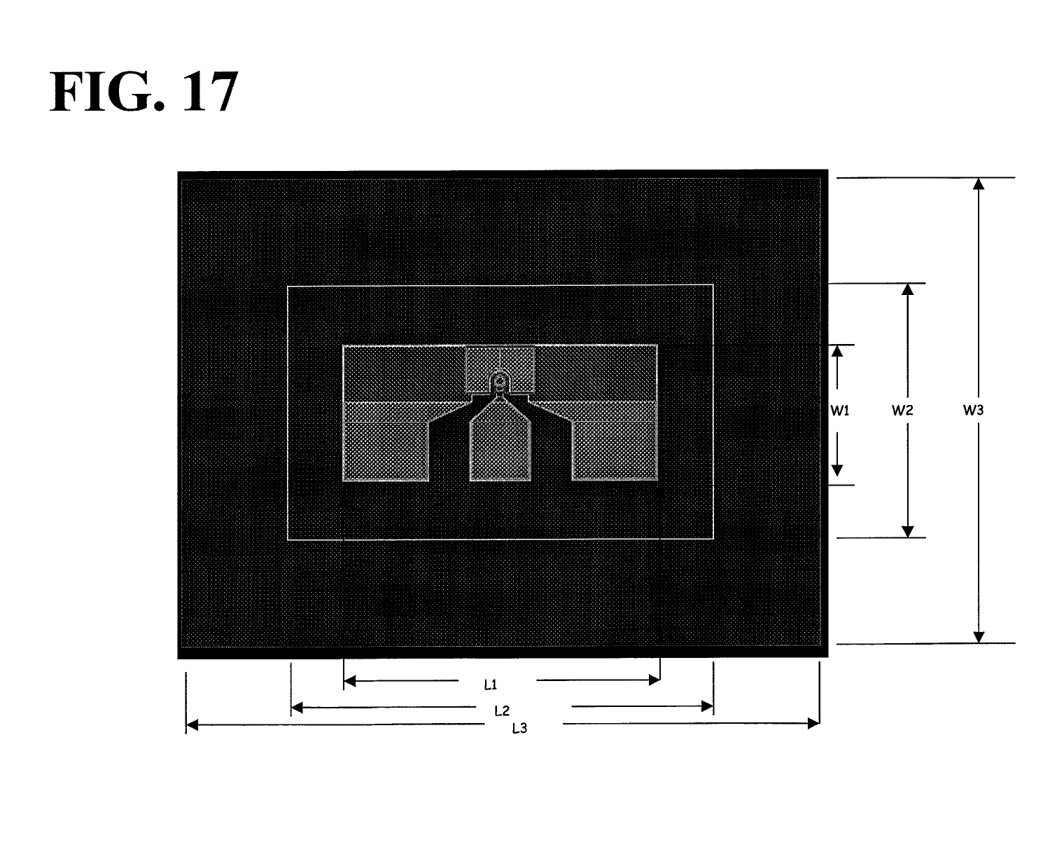

FIG. 17 shows an enlarged drawing of a typical photodetector shown in FIG. 16 that maybe used in the chip carrier of the present invention. The values for W₁, W₂ W₃, L₁, L₂, and L3 are typically 170 μm, 300 μm, 550 μm, 370 μm, 500 μm, and 750 μm, respectively.

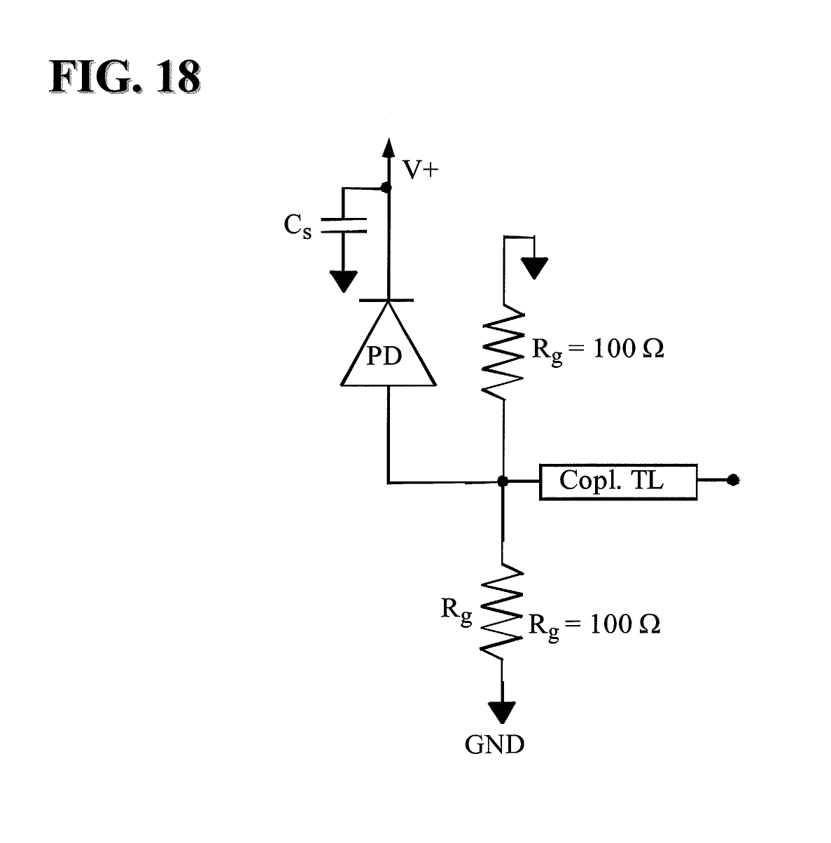

FIG. 18 illustrates a photodetector bias circuit as an example. The resistors are typically 100Ω and the capacitor is about 27 nF (12 kHz to 40+GHz).

It should be noted that the present invention has been described with “typical values” to facilitate the understanding of the invention and to provide examples. The invention also contemplates scaling up or scaling down the frequency of the signal carried by the connector by changing the size of the connector such as the diameter of the inner cylindrical portion and/or the width of the coplanar pins. Thus, frequencies lower or higher (100 GHz, for example) than 50 GHz are contemplated by the present invention.

Accordingly, the present invention provides a design for an RF connector that substantially provides a constant AC return path and ensures signal integrity at high frequencies including at 50 GHz and above. The shortcomings in the prior art connectors are overcome by providing a connector body having a system end formed to engage a coaxial connector, and a circuit end dimensioned to accommodate a planar circuit structure by using a flange capable of accommodating a chip carrier and a multiple pin configuration housed therein. Thus, the chip carrier is positioned very close to the connector pin to minimize the signal path resulting in a good signal even at very high frequencies.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A connector assembly for a radio frequency (RF) signal comprising:
a body;
a flange connected to the body and having a cavity; and
a plurality of pins extending from the flange,
wherein the cavity of the flange receives a chip carrier and the pins contact the chip carrier.

2. The connector assembly according to claim 1, wherein the plurality of pins have a coplanar pin configuration and include at least one signal pin and a ground pin.

3. The connector assembly according to claim 2, wherein the signal pin is connected to a device in the chip carrier.

4. The connector assembly according to claim 1, wherein a signal path between the signal pin of the connector and the device in the chip carrier is less than 500 mils.

5. The connector assembly according to claim 1, wherein a signal path between the signal pin of the connector and the device in the chip carrier is less than 400 mils.

6. The connector assembly according to claim 1, wherein a signal path between the signal pin of the connector and the device in the chip carrier is less than 300 mils.

7. The connector assembly according to claim 1, wherein a signal path between the signal pin of the connector and the device in the chip carrier is less than 200 mils.

8. The connector assembly according to claim 1, wherein a signal path between the signal pin of the connector and the device in the chip carrier is less than 100 mils.

9. The connector assembly according to claim 1, wherein a signal path between the signal pin of the connector and the device in the chip carrier is less than 75 mils.

10. The connector assembly according to claim 1, wherein a signal path between the signal pin of the connector and the device in the chip carrier is less than 40 mils.

11. The connector assembly according to claim 1, wherein the cavity receives a substantial portion of the chip carrier.

12. The connector assembly according to claim 1, wherein the chip carrier is substantially flush with a surface of the flange.

13. The connector assembly according to claim 1, wherein the cavity is located at a center portion of the flange.

14. The connector assembly according to claim 13, wherein the cavity is symmetrically centered in the flange.

15. The connector assembly according to claim 1, wherein the chip carrier includes one of a semiconductor device and an optical driver.

16. The connector assembly according to claim 1, wherein the plurality of pins have a coplanar pin configuration and include a signal pin and two ground pins, the signal pin being connected to a device in the chip carrier.

17. The connector assembly according to claim 16, wherein the chip carrier includes a conductive line connecting the signal pin of the connector to the device in the chip carrier.

18. The connector assembly according to claim 17, wherein the conductive line is coplanar with the signal pin.

19. The connector assembly according to claim 18, wherein the conductive line is bent prior to contacting the device.

20. The connector assembly according to claim 17, wherein the conductive line is less than 100 mils.

21. The connector assembly according to claim 17, wherein the conductive line is less than 50 mils.
